(19) United States
(12) Patent Application Publication
(10) Pub. No.: US 2005/0179149 A1
(43) Pub. Date: Aug. 18, 2005

(54) Mould, a method of manufacturing the same as well as its use

(76) Inventors: Hendrik Roelof Stapert, A A EINDHOVEN (NL); Emile Johannes Karel Verstegen, Eindhoven (NL); Johan Lub, Eindhoven (NL); Johan George Kloosterboer, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/509,477

(22) PCT Filed: Apr. 3, 2003
(86) PCT No.: PCT/IB03/01355

(51) Int. Cl. B29D 11/00; B29C 33/40

(52) U.S. Cl. 264/1.32; 249/134; 425/808; 264/337; 264/2.5; 264/1.38

(57) ABSTRACT

The present invention to a mould and a method of manufacturing such a mould. The mould comprises a plurality of components with moulding surfaces that together form a moulding cavity. At least a part of the mould components consists of fluoropolymer that is based on a fluorinated-alkyl chain that comprises a polymerisable group at both ends of the chain such as methacrylate, vinylether, or epoxide groups.

The present invention relates generally to a method of moulding materials in which a mould is used having a plurality of mould components with moulding surfaces together defining a moulding cavity, said method comprising the step of forming at least part of the mould components of a polymerisable material and polymerising said material under polymerisation conditions.

In addition the method relates to moulding optical components of organic material.

The replica process uses a mould or matrix having an accurately defined surface which is the negative of the desired optical profile of the replica lens. In the exact determination of the definition of the surface of the mould or matrix, the shrinkage of the synthetic resin of the replica lens has been taken into account. A small quantity of a liquid curable synthetic resin composition is provided on the surface of the mould. The lens body is then pressed with its refractive surface against the mould, or conversely, the synthetic resin spreading between the lens body surface and the mould surface. Instead of the mould, the lens body may alternatively be provided with the liquid synthetic resin composition. The synthetic resin is cured and the lens body together with the cured synthetic resin layer bonded thereto is removed from the mould. The free surface of the synthetic resin layer is the negative of that of the mould. The advantage of the replica process if that lenses with a complicated refractive surface, for example an aspherical surface, can be manufactured in a simple manner without requiring complicated grinding and polishing of the lens body. A lens body will suffice which has a simple refractive surface, for example, a spherical (convex or concave) surface.

Due to polymerization of the material the coating wants to shrink, but shrinkage is prohibited because of the confined space in which the lacquer is enclosed. As a result large mechanical forces will develop in the mould. The sign and magnitude of the forces are depending on the thickness of the lacquer and are thus a function of the lens radius. Because the total mould-lens system does not move during the photopolymerization process the mechanical force in the middle of the lens, where the lacquer is the thickest, have opposite sign as compared to the force more on the outside, at the thinner part of the lens. Thus when a lens is released from a mould via a peeling mechanism the driving force for release is the relaxation of shrinkage-induced mechanical pressure. But owing to this shrinkage, during the setting or curing of the moulding material not insubstantial stresses develop between the die members which may produce premature release or unmoulding of one of the die members which is prejudicial to both the die members and the lenses cast thereby. This uncontrolled premature unmoulding or release results in a lens having defects due to incorrect or improper polymerisation which must then be eliminated.

Further, this premature unmoulding or release is most often accompanied by damage to the edge of the optical component to be moulded as well as the corresponding edge of the die member having a concave moulding surface which is subjected to premature unmoulding or release.

Materials that have a high polymerization shrinkage thus are released relatively easy from a mould, but materials with lower shrinkage become more difficult to release. In such cases it is of major importance that the lens material has little or no interaction with the mould material, i.e. the materials should not wet each other. A measure for the wetting is the surface tension of the liquid-solid or solid-solid interface. The liquid is the lacquer monomer, the solid the mould surface. After polymerisation a solid-solid interface is obtained. When little interaction between 2 materials is desired the interfacial tension should be as low as possible.

Therefore, a common problem is the adhesion of the lens formed in the mould to one or both of the mould parts. Edge tears and chips, nicks or other surface defects as well as holes, voids, pits, i.e. areas on non-uniform thickness, and puddles formed in the lenses can occur when the adhesion is too great. This problem is exacerbated in processes for making lenses with thin edges or intricate edge geometries. Separating mould halves or mould parts without causing damage to the lens formed in the mould is thus critically important to commercial lens making processes.

One method for dealing with this problem has been the incorporation of additives such as zinc stearate in the mould materials or the inclusion of mould release agents. Unfortunately, these agents can adversely affect mould surface texture or bulk polymer properties. Adjustments to the time, temperature, and heating profile of the cure and demould processes has also been used to affect the adhesion of the lens to at least one of the mould parts. Often, the adjustments to the cure and demould processes that might be helpful in solving the adhesion problem negatively affect the quality of the lens made. Mechanical and optical properties can be seriously eroded or altered. Materials with a low interfacial tension are known and often contain no or little polar groups and Si—O or F containing groups. For example, well-know fluoropolymers with low interfacial tension are teflon and teflon-copolymers (Kel-F, AF1600, etc). Other coatings as Montacell and parylene are also frequently used. AF1600, Montacell and parylene have been applied on a mould for replication of lenses from materials with low polymerization shrinkage. Initially release of the lens was satisfactory, but the release deteriorated fast due to wear of the mould. In practice less than 10 lenses could be released.

Other strategies, such as adding reactive release agents to the mould-making formulation, can be followed to improve release from the mould, but haven't been successful. In one application, the replication of aspherical lenses for read-out of optical discs, glycidyl 3-(pentadeca-dienyl)phenylether (b.p. 305° C.) has been added as co-reactive additive to the conventional DGEBA-diphenyliodonium antimonyhexa-fluoroarsenate/anthracene mould formulation but this remained without improvement of the release properties in this demanding application aiming at the replication of a mould in which the replicating monomer is confined in a closed cavity. The same was observed upon the addition of 0.1% (epoxycyclohexylethyl)methylsiloxane(2-3%)-dimethylsiloxane(97-98%) copolymer to the mould-making formulation. The addition of glycidyl 1,1,2,2-tetrafluoroethyl ether (b.p. 143° C.) also proved unsuccessful.

U.S. Pat. No. 4,311,654 proposes a method of moulding materials requiring heat treatment for setting or curing in which a mould is used having a plurality of mould components with moulding surfaces together defining a moulding cavity, comprising forming at least part of one of the mould components of a fusible material, the fusible material extending along at least part of the associated moulding surface and outwardly therefrom, the fusible material effectively releasing the material moulded in the moulding cavity in the course of setting or curing. The fusible material employed may be paraffin wax which has a drop point of the order of 60° C. to 62° C., therefore included in the range of temperatures corresponding to the heat treatment to be applied for the setting or curing of polyethylene glycol diallyl dicarbonate catalyzed with 3% by weight of isopropyl percarbonate.

It is thus desired to have materials with intrinsic release properties that can be shaped in the desired form, such as moulds with an a-spherical lens profile. The profile has to be controlled very accurately within tens of nanometers.

Another object of the present invention is to tune such that the interfacial tension is such that release of the polymerised lens is facilitated.

A further object of the present invention is to provide a class of reactive materials that provides excellent release of (photo)cured products from pre-shaped moulds made from these materials.

An object of the present invention is to provide a mould that omits the need for applying extra surface coatings on these moulds.

In addition, another object is to provide a mould wherein the release properties remain constant even after high numbers of products cured and released from a mould prepared from said polymerisable materials.

Therefore, the present method of moulding materials is characterized in that the starting material before polymerisation is a polymerisable compound of the formula:

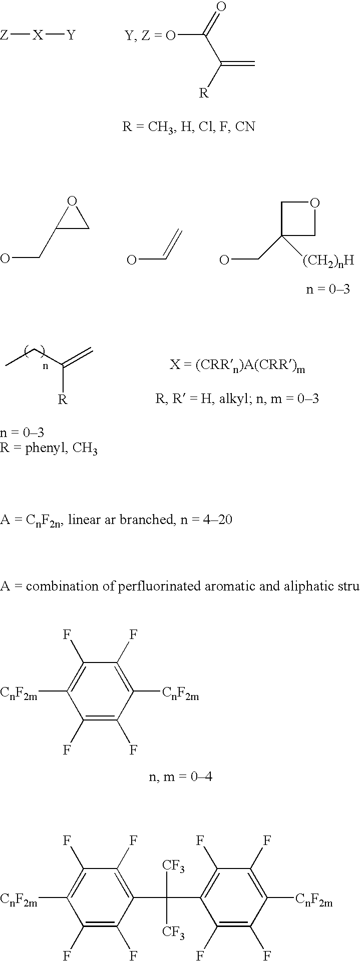

wherein

Z and Y independently represent polymerisable groups.

The above-identified polymerisable materials have intrinsic release properties. This means that the addition of extra release coatings or release agents is not necessary. Thus, deterioration of the mould over time during operation is not expected to result in a decrease in the release properties.

It is preferred that the polymerisable groups Z en Y are independently chosen from the groups consisting of (meth)acrylate, oxetane, glycidylether, allylether, epoxy, vinylester and vinylether, or mixtures thereof.

Z or Y can be also a thiol group in combination with other radically polymerisable monomers in such a way that crosslinked polymers are obtained. For example, when Y is a thiol group, it is preferred to have a ratio Z/Y higher than or equal to 1 in order to obtain a crosslinked system. Furthermore, when using such a thiol group it is possible to influence the crosslinking density of the polymerised material.

A particularly preferred starting material is 2,2,3,3,4,4,5,5-octafluoro 1,6-hexanediol-dimethacrylate wherein both Y and Z are methacrylate groups.

Another particularly preferred starting material is 2,2′-(2,2,3,3,4,4,5,5-octafluoro 1,6-hexanyloxymethyl)diepoxide, wherein both Y and Z are glycidylether groups, wherein the shrinkage during setting or curing of the material is much lower compared to the polymerisable materials.

As outlined above the driving force for lens release is a function of the polymerization shrinkage in confined space in which the replication takes place. For materials with a smaller polymerization shrinkage a mould material with a lower interfacial tension is likely needed as compared to materials with a higher polymerization shrinkage. The present inventors have found that by varying the F/C ratio of reactive monomers, materials can be obtained that provide excellent release for lenses made of materials with a low polymerization shrinkage and that can be shaped in the desired a-spherical mould profile. Therefore, it is desired that the F/C-ratio (Fluoro-Carbon ratio) of said polymerisable compound should be higher or equal to 8/14.

The moulding cavity is shaped for a moulding and optical element, such as ophthalmic lenses, collimators, prisms, phase gratings, mirrors, objective lenses for optical recording.

Furthermore, the present invention relates to a method of moulding materials in which a mould is used having a plurality of mould components with moulding surfaces together defining a moulding cavity, said method comprising the step of forming at least part of the mould components of a polymerisable material, polymerising said material for forming the mould, filling the moulding cavity with a mixture of moulding material, applying UV-light or heat to said moulding material in the mould to set or cure the moulding material, continuing the UV-light or heat treatment until sufficient stiffness has developed in the moulded article and removing the moulded article thus made from the mould, wherein said mould is made of polymerising a polymerisable compound of formula:

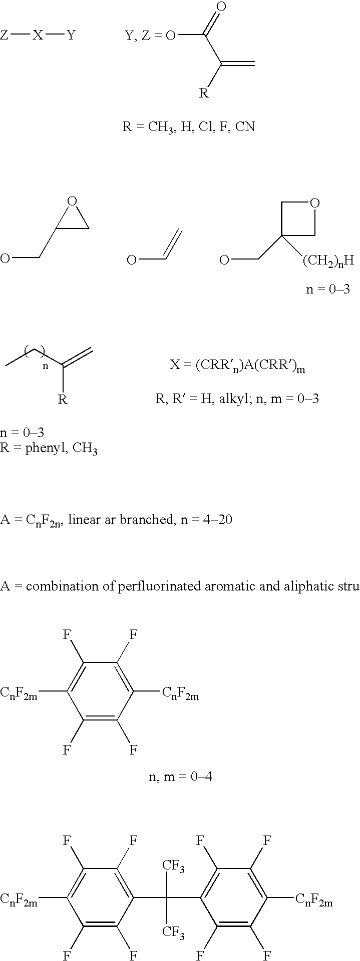

wherein

Z and Y independently represent polymerisable groups.

In addition, the present invention relates to a mould for making optical components comprising a plurality of mould components of mould components with moulding services together defining a moulding cavity, wherein said mould is obtained by polymerising a mixture comprising, as a main constituent thereof, a polymerisable compound of the aforementioned formula.

In addition, the aforementioned polymerisable groups Z and Y are independently chosen from the groups consisting of (meth)acrylate, oxetane, glycidylether, allylether, epoxy, vinylether and vinylester, or mixtures thereof.

Z or Y can be also a thiol group in combination with other radically polymerisable monomers in such a way that crosslinked polymers are obtained.

The shape of the mould may be spherical or a-spherical made of said polymerisable material, wherein the aspect ratio of the layer thickness made of said material can be as large as 50.

The aforementioned drawbacks are overcome according to the present invention with a polymerisable material used as at least part of the mould components.

These and other features and advantages of the invention will be more discussed in the example which follows, wherein the scope of the invention is not limited to the illustrated example.

### EXAMPLE 1

### General Method for Making a Working Mould

Depending on the desired lens shape an aspherical mould was made from Ni or brass by conventional mechanical polishing techniques. The shape of the mould is such that after photopolymerisation the desired lens shape is obtained. From this mould a positive was made by photoreplication using an EFOS UV curing apparatus. The positive was made from hydroxyethyloxybisphenol-A dimethacrylate (diacryl101, AKZO-Nobel, Arnhem, The Netherlands). From the positive a working mould was obtained by photoreplication of the desired material of which a small drop is put in a spherical pit polished in quartz, glass or plastic.

### EXAMPLE 2

### Formulation of Mould Making Mixture

A mixture of 2,2,3,3,4,4,5,5-octafluoro 1,6-hexanediol-dimethacrylate and 4 wt % of DMPA (=α,α-dimethoxy-α-phenylacetophenone), sold under the name Irgacure 651, was made. A small drop (10-20 μL) of the mixture was put in a spherical pit with a radius of 3 mm that was polished in a thin quartz plate. The pit had been silanized with 3-methacryloyloxypropyl trimethoxysilane (A174). The aspherical positive was contacted with the material in the pit by applying a pressing force of 100 gram for 1 second and 600 gram for 7 seconds. During these 7 seconds UV light (320-390 nm) was irradiated using an intensity of 100 mW/cm². A second polymer layer was applied using the same procedure. The working mould was then heated to 140° C. for 14 hrs and cooled to room temperature.

### EXAMPLE 3

### Lens Replication of DGEBA from an Aspherical Mould Made from 2,2,3,3,4,4,5,5-octafluoro 1,6-hexanediol-dimethacrylate

A small volume of DGEBA with 4.5 wt % diphenyliodonium antimonyhexafluoroarsenate and 0.5 wt % anthracene was applied on a polished halve spherical ball. The ball had been silanized with 3-glycidyloxypropyl trimethoxysilane (A187). The ball with monomer was brought into contact with the working mould as described in example 2. Photopolymerization was induced by applying UV light (320-390 mm) of 100 mW/cm² for 7 seconds. Lenses were then released from the mould and subsequently heat treated for 8 hrs at 110° C. The total (lens) replication process was repeated many times and the surfaces of the mould and lenses were visually inspected. It was observed that after replication of 100 lenses no deterioration of both lens as well as mould surface had occurred. Both surfaces remained very smooth and release of the lens from the mould remained very good.

An anti-reflexcoating can be subsequently applied on the DGEBA surface.

### EXAMPLE 4

### Synthesis of 2,2′-(2,2,3,3,4,4,5,5-octafluoro 1,6-Hexanyloxymethyl)Diepoxide According to Method 1

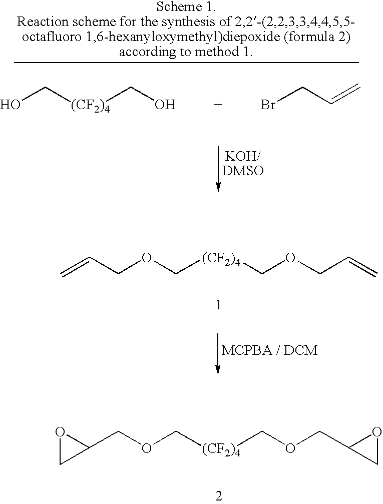

### EXAMPLE 5

### Synthesis of 2,2,3,3,4,4,5,5-Octafluoro 1,6-Hexenyl-Diallylether (Formula 1)

50 g of freshly milled potassium hydroxide (0.76 mole, 85%) was stirred for 5 minutes with 150 ml of dimethylsulfoxide. Then was added: 50 g of 2,2,3,3,4,4,5,5-octafluoro 1,6-hexanediol (0.2 mole). After stirring for 5 minutes, 37 ml of allylbromide (0.42 mole) was added dropwise. Stirring was continued for one night. 0.51 of diethylether and 0.41 of water were added. After separation, the organic layer was extracted twice with 400 ml of water and once with 400 ml of brine. After drying over magnesium sulphate, the diethylether was evaporated at 60° C. 60 g of a yellow oil (92%) was obtained.

### EXAMPLE 6

### Synthesis of 2.2′-(2,2,3,3,4,4,5,5-Octafluoro 1,6-Hexanyloxymethyl)Diepoxide (Formula 2).

51 g of 2,2,3,3,4,4,5,5-octafluoro 1,6-hexenyldiallylether (formula 1, 0.18 mole, prepared according to example 5) was dissolved in 750 ml of dichloromethane. To this solution was added 54 g of technical 3-chloroperoxybenzoic acid (70% pure, 0.22 mole). Stirring was continued for one night. The solution was filtered and 100 ml of 10% sodium sulphite solution was added. An exothermic reaction occurred. After separation the dichloromethane solution was dropped slowly in 400 ml of a 5% sodium bicarbonate solution. After the carbon dioxide generation had stopped this was repeated. After extraction with 500 ml of brine, the solution was dried over magnesium sulphate and evaporated. The crude product was purified by column chromatography (SiO₂, dichloromethane). 34 g of a colourless oil was obtained (46%).

### EXAMPLE 7

### Synthesis of 2,2′-(2,2,3,3,4,4,5,5-Octafluoro 1,6-hexanyloxymethyl)Diepoxide (Formula 2) According to Method 2.

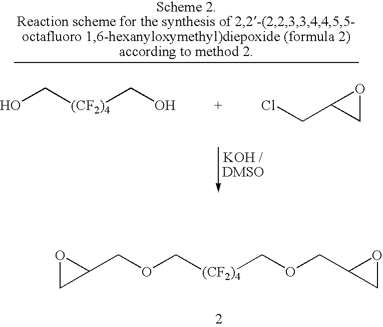

20 g of freshly milled potassium hydroxide (0.3 mole, 85%) was stirred for 5 minutes with 60 ml of dimethylsulfoxide. Then was added: 20 g of 2,2,3,3,4,4,5,5-octafluoro 1,6-hexanediol (0.4 mole). After stirring for 5 minutes, 78g of epichlorohydrin (0.8 mole) was added dropwise. Stirring was continued for one night. 200 ml of diethylether and 150 ml of water were added. After separation, the organic layer was extracted twice with 150 ml of water and once with 150 ml of brine. After drying over magnesium sulphate, the diethylether was evaporated. The crude product was purified by column chromatography (SiO₂, dichloromethane). 13.5 g of a light yellow oil was obtained (42%).

1. A method of moulding materials in which a mould is used having a plurality of mould components with moulding surfaces together defining a moulding cavity, said method comprising the step of forming at least part of the mould components of a polymerisable material and polymerising said material under polymerisation conditions, characterized in that, the starting material before polymerisation is a polymerisable compound of the formula: 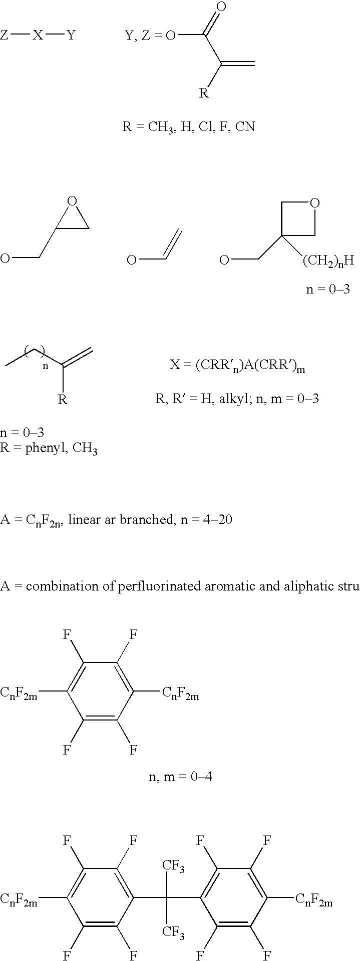
wherein
Z and Y independently represent polymerisable groups.

2. A method according to claim 1, characterized in that said polymerisable groups Z and Y are independently chosen from the groups consisting of (meth)acrylate, oxetane, glycidylether, allylether, epoxy, vinylether and vinylester, or mixtures thereof, wherein Z or Y can be also a thiol group in combination with other radically polymerisable monomers in such a way that crosslinked polymers are obtained.

3. A method according to claim 1, characterized in that the starting material is 2,2′-(2,2,3,3,4,4,5,5-octafluoro 1,6-hexanyloxymethyl)diepoxide, wherein both Y and Z are glycidylether groups.

4. A method according to claim 1, characterized in that the starting material is 2,2,3,3,4,4,5,5-octafluoro 1,6-hexanediol-dimethacrylate wherein both Y and Z are methacrylate groups.

5. A method according to claim 1, characterized in that the F/C-ratio (Fluoro-Carbon ratio) of said polymerisable compound should be higher or equal to 8/14.

6. A method according to claim 1, characterized in that the moulding cavity being shaped for moulding an optical component therein.

7. A method of moulding materials in which a mould is used having a plurality of mould components with moulding surfaces together defining a moulding cavity, said method comprising the step of forming at least part of the mould components of a polymerisable material, polymerising said material for forming the mould, filling the moulding cavity with a mixture of moulding material, applying UV-light or heat to said moulding material in the mould to set or cure the moulding material, continuing the UV-light or heat treatment until sufficient stiffness has developed in the moulded article and removing the moulded article thus made from the mould, wherein said mould is made of polymerising a polymerisable compound of the formula 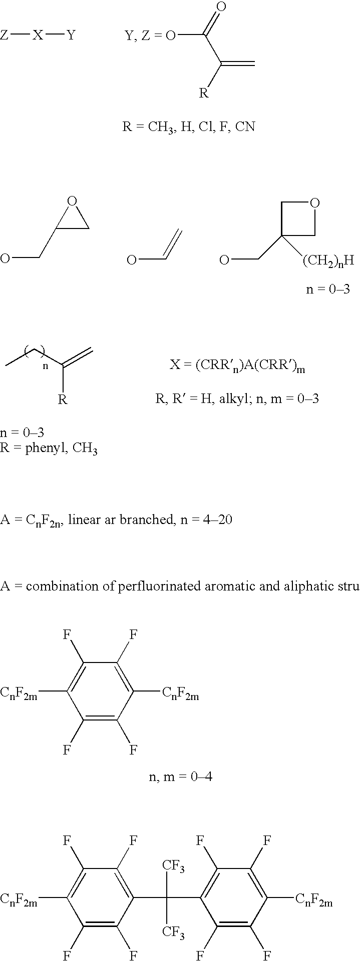
wherein
Z and Y independently represent polymerisable groups.

8. A method according to claim 7, characterized in that said polymerisable groups Z and Y are independently chosen from the groups consisting of (meth)acrylate, oxetane, glycidylether, allylether, epoxy, vinylether and vinylester, or mixtures thereof, wherein Z or Y can be also a thiol group in combination with other radically polymerisable monomers in such a way that crosslinked polymers are obtained.

9. A method according to claim 7, characterized in that the starting material is 2,2,3,3,4,4,5,5-octafluoro 1,6-hexanediol-dimethacrylate wherein both Y and Z are methacrylate groups.

10. A method according to claim 7, characterized in that the starting material is 2,2′-(2,2,3,3,4,4,5,5-octafluoro 1,6-hexanyloxymethyl)diepoxide wherein both Y and Z are glycidylether groups.

11. A method according to claim 7, characterized in that the F/C-ratio (Fluoro-Carbon ratio) of said polymerisable compound should be higher or equal to 8/14.

12. Optical components obtained according to a method as disclosed in claim 7.

13. A mould for making optical components comprising a plurality of mould components with moulding surfaces together defining a moulding cavity, wherein said mould is obtained by polymerising a mixture comprising, as a main constituent thereof, a polymerisable compound of the formula: 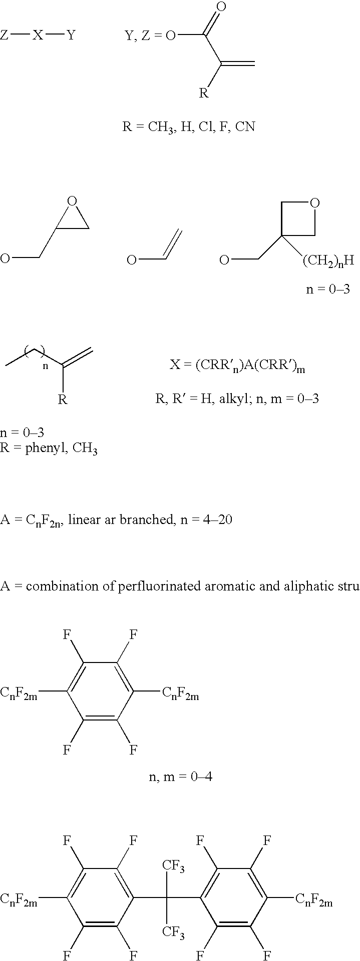
wherein
Z and Y independently represent polymerisable groups.

14. A mould according to claim 13, characterized in that said polymerisable groups Z and Y are chosen from the group consisting of (meth)acrylate, oxetane, glycidylether, allylether, epoxy, vinylether and vinylester, or mixtures thereof, wherein Z or Y can be also a thiol group in combination with other radically polymerisable monomers in such a way that crosslinked polymers are obtained.

15. A mould according to claim 13, characterized in that the starting material is 2,2,3,3,4,4,5,5-octafluoro 1,6-hexanediol-dimethacrylate wherein both Y and Z are methacrylate groups.

16. A mould according to claim 13, characterized in that the starting material is 2,2′-(2,2,3,3,4,4,5,5-octafluoro 1,6-hexanyloxymethyl)diepoxide wherein both Y and Z are glycidylether groups.

17. A mould according to claim 13, characterized in that the F/C-ratio (Fluoro-Carbon ratio) of said polymerisable compound should be higher or equal to 8/14.

18. A mould according to claim 13, characterized in that the shape of the mould being spherical or a-spherical made of said polymerisable material wherein the aspect ratio of the layer thickness made of said material can be as large as 50.
